(19) United States
(12) Patent Application Publication
(10) Pub. No.: US 2026/0350824 A1
(43) Pub. Date: Nov. 5, 2026

(54) HOLOGRAPHIC COMMUNICATION SYSTEM

(71) Applicant: Telefonaktiebolaget LM Ericsson (publ), Stockholm (SE)

(72) Inventors: Charles KINUTHIA, Stockholm (SE); Volodya GRANCHAROV, Stockholm (SE)

(73) Assignee: Telefonaktiebolaget LM Ericsson (publ), Stockholm (SE)

(21) Appl. No.: 19/133,960

(22) PCT Filed: Dec. 1, 2022
(86) PCT No.: PCT/SE2022/051128

§ 371 Date: May 29, 2025

(51) Int. Cl. G06T 7/50; G06T 9/00

(52) U.S. Cl. CPC G06T 7/50; G06T 9/002; G06T 2207/20084

(57) ABSTRACT

A method for with a holographic communication system. The method includes obtaining a measured depth map associated with at least a first image and obtaining an estimated depth map associated with at least the first image. The method also includes obtaining a similarity measure indicating a similarity between the measured depth map and the estimated depth map. The method also includes determining, based at least in part on the similarity measure, that a criteria is met, wherein determining that the criteria is met comprises determining whether the similarity measure satisfies a condition. The method further includes refraining from providing the measured depth map to the receiving device as a result of determining that the criteria is met.

### TECHNICAL FIELD

Disclosed are embodiments related to a holographic communication system.

### BACKGROUND

In recent years extended reality (XR) applications (e.g., virtual reality applications (VR), augmented reality (AR) applications, mixed reality applications (MR)) have become increasingly popular. One example of an XR application is an application that employs holographic communication, which refers to the transmission of data that enables a device receiving the data to produce a three-dimensional (3D) image.

Typically, in a holographic communication system, a sending device obtains image data for an image (e.g., a frame of a video) and, for each image, corresponding depth data (a.k.a., a “depth map”) associated with the image (e.g., for each pixel of the image, there is a depth value that indicates the distance from the sensor to the respective point on the object corresponding to the pixel). The image data can be captured by, for example, a smartphone's camera and the depth map can be captured by a smartphone's light detection and ranging (LiDAR) sensor and/or other sensors. The image data and the corresponding depth map are encoded and the encoded data is added to a bitstream that is then transmitted over a network to a receiving device. A depth map can be captured by means of active scanning (e.g., LiDAR in iPhone 14 Pro (see, e.g., apple(dot)com/iphone-14-pro/specs/)), or passive scanning (e.g., stereo camera setup as in Intel® RealSense™ Depth Camera D435 (see, e.g., www(dot)intelrealsense(dot)com/depth-camera-d435/)). A depth map contains distance information (“depth values”) indicating distances from a sensor position to points on the surface of an object in the physical scene. For example, a depth map may be a matrix of distance values where each distance value indicates a distance from a sensor to a point on a surface.

At the receiving device, the encoded data is decoded to recover the image data and depth map. This data is then fed to a rendering and visualization module. XR glasses in communication with the receiving device can be used to display the images in 3D as holograms. This application allows the rendering of a 3D reconstruction of a person using the sending device (e.g., the person is rendered as a hologram using XR glasses for a more immersive experience).

U.S. patent publication no. 20190025587 A1 describes a holographic projection technology for use in the presentation of a 3D imaging effect to a user, such as computer-generated holography. U.S. patent publication no. US 2022057750 A1 describes generating a computer-generated hologram (CGH) of an object using a “depth map method.”

### SUMMARY

Certain challenges presently exist. For instance, for a holographic communication system to work well (i.e., to produce at the receiving device 3D images of sufficient quality) the network between the sending device and the receiving device must provide sufficient bandwidth, but this is not always feasible because the load on the network can be variable. That is, with existing compression and networking technology, the network occasionally does not provide the required bandwidth to transmit the required image and depth map, and this can lead to a drop of quality in the generated 3D images. The resulting visual perceptual artifacts can affect the overall perception of the holographic communication.

Accordingly, in one aspect there is provided a method that includes obtaining a measured depth map associated with at least a first image and obtaining an estimated depth map associated with at least the first image. The method also includes obtaining a similarity measure indicating a similarity between the measured depth map and the estimated depth map. The method also includes determining, based at least in part on the similarity measure, that a criteria is met, wherein determining that the criteria is met comprises determining whether the similarity measure satisfies a condition. The method further includes refraining from providing the measured depth map to the receiving device as a result of determining that the criteria is met.

In another aspect there is provided a computer program comprising instructions which when executed by processing circuitry of a sending device causes the sending device to perform any of the methods disclosed herein. In one embodiment, there is provided a carrier containing the computer program wherein the carrier is one of an electronic signal, an optical signal, a radio signal, and a computer readable storage medium. In another aspect there is provided a sending device that is configured to perform the methods disclosed herein. The sending device may include memory and processing circuitry coupled to the memory.

An advantage of the embodiments disclosed herein is that they reduce the bandwidth need of a holographic communication system because a measured depth map does not always need to be provided to the receiving device. Rather, a depth map associated with one or more images is transmitted only when a certain criteria is met (e.g., the estimated depth map is not accurate enough). This not only allows holographic communication systems to operate under bandwidth limitations, but also reduces the load on the network as well as reducing the load on the battery of the sending device, thereby extending the life of the battery.

### BRIEF DESCRIPTION OF THE DRAWINGS

The accompanying drawings, which are incorporated herein and form part of the specification, illustrate various embodiments.

FIG. 1 illustrates a communication system according to some embodiments.

FIG. 2A is a functional block diagram of a sending device according to some embodiments.

FIG. 2B is a functional block diagram of a receiving device according to some embodiments.

FIG. 3 is a flowchart illustrating a process according to some embodiments.

FIG. 4 is a block diagram of a sending device according to some embodiments.

### DETAILED DESCRIPTION

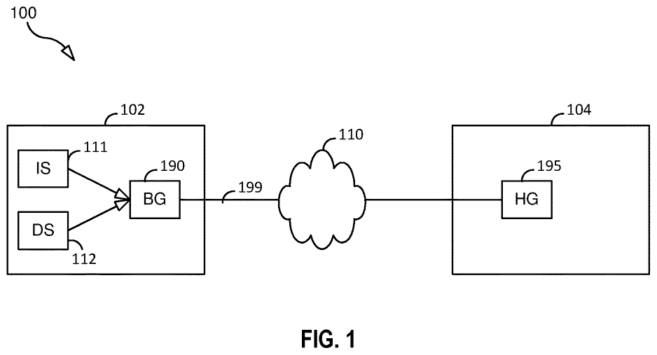

FIG. 1 illustrates a communication system 100 according to an embodiment. System 100 includes a sending device 102 (e.g., smartphone, laptop, computer, tablet, drone, etc.) communicating via a network 110 (e.g., the Internet) with a receiving device 104. In the particular use case illustrated, communication system 100 is a holographic communication system in which sending device 102 includes an image sensor (IS) 111 (e.g., camera) for producing image data (e.g., the image data may include a matrix of luma values and/or a matrix of chroma values) corresponding to an image and a depth sensor (DS) 112 (e.g., LiDAR sensor) for producing a depth map (a.k.a., “depth data”) for each image (e.g., video frame).

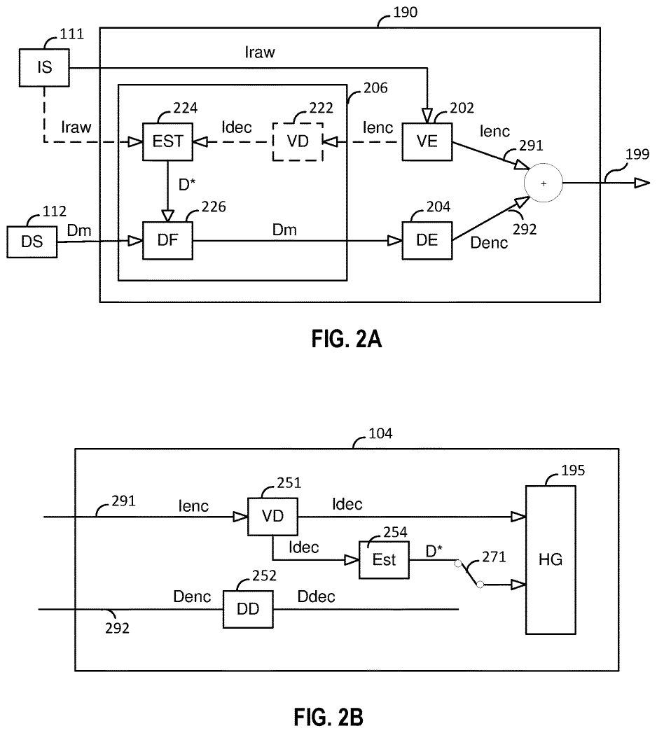

In one embodiment, sending device 102 has a bitstream generator (BG) 190 for generating a bitstream 199 which can be stored for later use by receiving device 104 and/or transmitted to receiving device 104 via network 110, where the bitstream contains both an image data bitstream 291 (see FIG. 2A) containing image data (e.g., the image data as captured by image senor 111 or an encoded version thereof) and a depth data bitstream 292 (see FIG. 2A) containing depth data (e.g., the depth data as captured by depth sensor 112 or an encoded version thereof), and receiving device 104 includes a hologram generator (HG) 195 configured to use the image data and depth data to display a hologram to the user of the receiving device. In some embodiments, rather than outputting a single bitstream 199, sending device 102 outputs two separate bitstreams: the image bitstream containing the image data and the depth bitstream containing the depth data.

This disclosure describes improvements for use in the case of a network limitation that prevents the required high-quality image and depth data to be transmitted to the receiving device. The improvement is to selectively provide the depth data. For example, a depth map associated with an image may or may not be provided to the receiving device (i.e., included in the bitstream) depending on whether a criteria is met the receiving device is able to produce a high-quality estimated depth map (i.e., an estimated depth map that is similar enough to the corresponding measured depth map).

In one embodiment, at the sending device, image data is encoded and locally decoded by a video codec (e.g., Versatile Video Coding (VVC) codec) to produced decoded image data. The decoded image data is used as input to a depth map estimator (e.g., a neural network or other machine learning (ML) model) to produce a depth map estimate. A value (e.g., an error term) is calculated indicating how close the depth map estimate is to the measured depth map (i.e., the depth map captured by the depth sensor or a depth map derived from the depth map captured by the depth sensor). In one embodiments, if the value is an error value and the error is below a certain threshold, then the measured depth map associated with the image is not included in the bitstream. Conversely, if the value is an error value and the error is above the threshold, the measured depth map is included in the bitstream (e.g., encoded and transmitted to the receiver). On the receiving device, if a depth map associated with an image was not received from the sender, then an identical depth map estimator to that at the sending device uses the decoded image data for the image to produce a depth map estimate which is then used with the image data to produce the 3D image, otherwise the depth map received from the sending device is used to produce the 3D image.

FIG. 2A illustrates an embodiment of sending device 102. In the embodiment shown, in addition to including image sensor 111 and depth sensor 112, sending device 102 includes: i) an image encoder 202 (a.k.a., video encoder (VE)) for producing, for each of one or more images, encoded image data (I_{enc}) for the image from the raw image data (I_{raw}) for the image provided by image sensor 111, which encoded image data is included in bitstream 291 sent to receiving device 104 and ii) a depth data transmission controller (or controller for short) 206 for controlling whether or not, for each measured depth map, sending device 102 will transmit the depth map to receiving device 104 (e.g., for determining whether or not to include the depth map in the bitstream 292.

In one mode of operation (“mode 1”), controller 206 receives encoded image data (I_{enc}) corresponding to an image (i.e., I_{enc} was produced by VE 202) and employs a video decoder (VD) 222 to decode the encoded image data produced by VE 202, thereby producing decoded image data (I_{dec}) corresponding to the image. I_{dec} is then used as input to a depth map estimator (EST) 224 (e.g., a neural network) to produce an estimated depth map (D*) associated with the image. In another mode of operation (“mode 2”), controller 206 receives I_{raw} and I_{raw} is used as the input to EST 224 to produce the estimated depth map (D*) associated with the image.

In either mode of operation, a decision function (DF) 222 is configured to decide, for each measured depth map, whether to include the measured depth map (or an encoded version thereof) in bitstream 292. The decision is based on a measure of the similarity between the measured depth map for the image and the estimated depth map for the image (e.g., an error value or similarity value).

For example, in one embodiment, for each measured depth map produced by DS 112, DF 222 computes an error value (e) indicating an error between the measured depth map and the corresponding estimated depth map estimated by EST 224; the error value (e) is then compared to a threshold (T). The error value can be computed as the p-norm (e.g., e=∥Dm−D*∥ₚ), where Dm is the measured depth map (e.g., as measured by the LiDAR) and p is ≥1. If the error e is above T, a decision is made to add Dm (or an encoded version thereof) to the bitstream 292, otherwise the depth map is not added to the bitstream 292, and the receiving device uses its own estimated depth map to produce the 3D image.

This means that a measured depth map associated with an image is provided to the receiving device only when the corresponding estimated depth map (i.e., the estimated depth map produced based on the image data for the image) is not good enough.

In some embodiments, if a measured depth map is to be transmitted, a depth map encoder (DE) 204 is used for encoding the measured depth map to produce an encoded depth map (D_{enc}) based on the measured depth map (Dᵣₘ). The DE can for example encode the depth map as PNG (see reference [3]). As a result, the image data is continuously transmitted while the depth information is transmitted on an as needed basis (i.e., when Dₑₛₜ is not good enough).

FIG. 2B further illustrates an embodiment of receiving device 104. At the receiving device, the encoded image data (I_{enc}) in the bitstream 291 is decoded by VD 251 to produce decoded image data (I_{dec}). An EST 254, which is identical to EST 224 in sending device 102, uses decoded image data for an image to produce a depth map estimate D* associated with the image. If an encoded depth map for the image was not included in bitstream 292, which means that DF 226 determined that D* is good enough, D* and I_{dec} are used by HG 195 to produce the 3D image. If, on the other hand, an encoded depth map for the image is included in bitstream 292 (i.e., D* is not good enough) it is first decoded by a depth decoder (DD) 252 to produce a decoded depth map (D_{dec}) which, together with I_{dec}, is used by HG 195 to produce the 3D image.

In one embodiment, controller 206 can switch between mode 1 and mode 2 based on a condition being satisfied (e.g., the video codec operating point satisfying a condition).

The EST (e.g., neural network (NN)) used to produce the depth estimate, operates at certain quality range of input images. If the codec bitrate is low, the difference between the image from the capturing device and decoded image will increase and the EST at the encoder and decoder will be presented with increasingly different input and therefore the estimated encoder and decoder depth will start to deviate. In this case it is advantageous to use mode 1. If the codec bitrate is high, one can assume the difference between the image from the capturing device and the decoded image is not as large and therefore switch to mode 2. The motivation for this is to have both the neural network on the sender and receiver use similar inputs and therefore produce very similar depth map estimates. This switching scheme can be realized as: if bn<B, then use mode 1, else use mode 2, where bn is the codec bitrate and B is the bitrate threshold at which EST performance starts to get affected.

The EST runs in real-time both on the sender and receiver side. It could be based on FastDepth (see reference [2]). In addition to single image depth estimation, a mapping {Î_{N-k}, . . . , Î_{N}}→D*_{N}, could be used. Here k is the number of frames needed by neural network, N is a time stamp indicating the current frame.

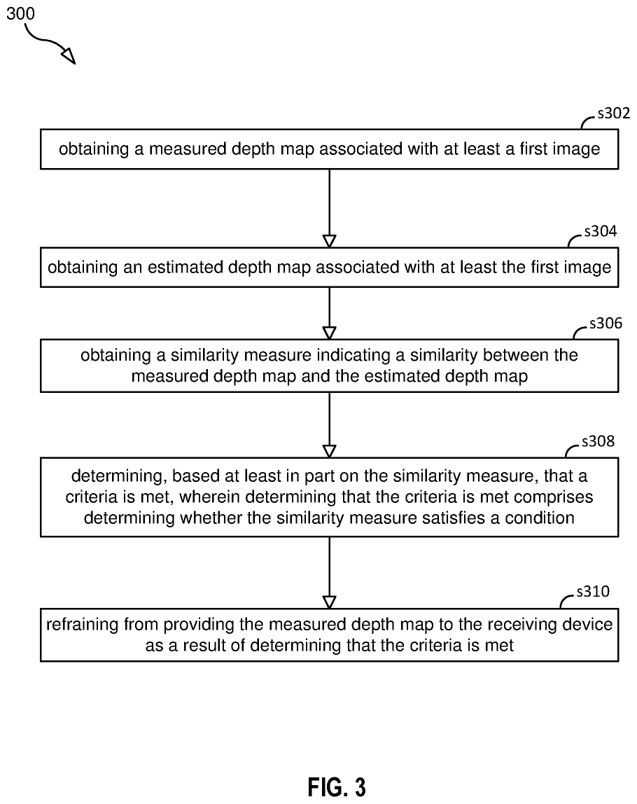

FIG. 3 is a flow chart illustrating a process 300 according to an embodiment. Process 300 may begin in step s302.

Step s302 comprises obtaining a measured depth map associated with at least a first image.

Step s304 comprises obtaining an estimated depth map associated with at least the first image.

Step s306 comprises obtaining a similarity measure indicating a similarity between the measured depth map and the estimated depth map.

Step s308 comprises determining, based at least in part on the similarity measure, that a criteria is met, wherein determining that the criteria is met comprises determining whether the similarity measure satisfies a condition.

Step s310 comprises refraining from providing the measured depth map to the receiving device as a result of determining that the criteria is met.

In some embodiments, the method is performed by a sending device, and the sending device is configured to provide the measured depth map to the receiving device as a result of determining that the criteria is not met.

In some embodiments, the similarity measure is an error value, and the error value satisfies the condition if the error value is less than a threshold. In some embodiments, the error value is equal to: ∥Dm−D*∥ₚ, where p≥1, Dm is the measured depth map, and D* is the estimated depth map. In some embodiments, the criteria is met if the error value is less than the threshold.

In some embodiments, the criteria is met if: i) the error value is less than the threshold and ii) bandwidth available to provide the measured depth map to the receiving device is less than a B, where B is a bandwidth threshold.

In some embodiments, obtaining the estimated depth map comprises inputting image data into a neural network and obtaining the estimated depth map from the neural network. In some embodiments the process also includes: encoding raw image data for the first image to produce encoded image data for the first image and decoding the encoded image data to produce decoded image data for the first image, wherein the image data input into the neural network comprises the decoded image data. In some embodiments, the image data input into the neural network comprises raw image data for the first image.

In some embodiments the process also includes encoding raw image data for the first image to produce encoded image data for the first image and decoding the encoded image data to produce decoded image data for the first image, wherein the image data input into the neural network comprises the decoded image data if a bitrate, bn, is less than a threshold, otherwise the image data input into the neural network comprises the raw image data.

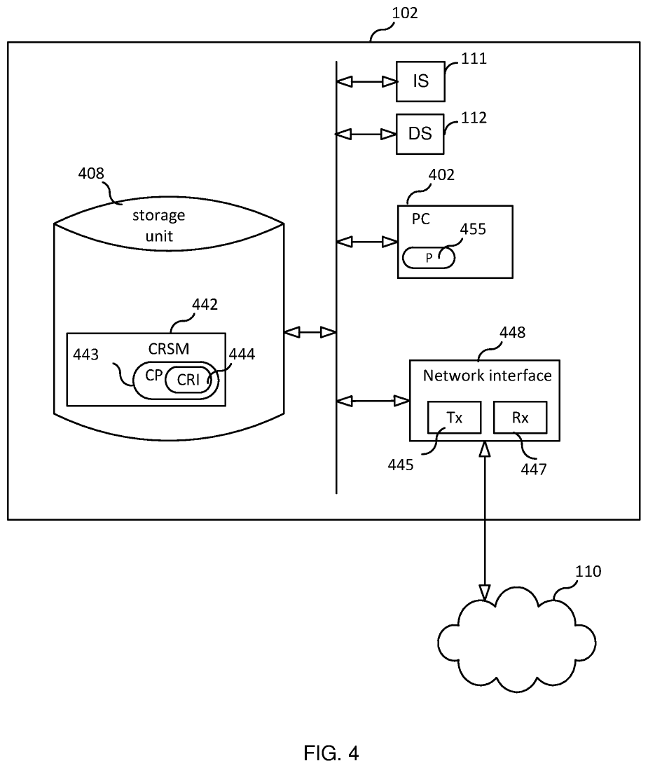

FIG. 4 is a block diagram of sending device 102, according to some embodiments. As shown in FIG. 4, sending device 102 may comprise: processing circuitry (PC) 402, which may include one or more processors (P) 455 (e.g., one or more general purpose microprocessors and/or one or more other processors, such as an application specific integrated circuit (ASIC), field-programmable gate arrays (FPGAs), and the like), which processors may be co-located in a single housing or in a single data center or may be geographically distributed (i.e., sending device 102 may be a distributed computing apparatus); at least one network interface 448 (e.g., a physical interface or air interface) comprising a transmitter (Tx) 445 and a receiver (Rx) 447 for enabling sending device 102 to transmit data to and receive data from other nodes connected to a network 110 (e.g., an Internet Protocol (IP) network) to which network interface 448 is connected (physically or wirelessly) (e.g., network interface 448 may be coupled to an antenna arrangement comprising one or more antennas for enabling sending device 102 to wirelessly transmit/receive data); and a storage unit (a.k.a., “data storage system”) 408, which may include one or more non-volatile storage devices and/or one or more volatile storage devices. In embodiments where PC 402 includes a programmable processor, a computer readable storage medium (CRSM) 442 may be provided. CRSM 442 may store a computer program (CP) 443 comprising computer readable instructions (CRI) 444. CRSM 442 may be a non-transitory computer readable medium, such as, magnetic media (e.g., a hard disk), optical media, memory devices (e.g., random access memory, flash memory), and the like. In some embodiments, the CRI 444 of computer program 443 is configured such that when executed by PC 402, the CRI causes sending device 102 to perform steps described herein (e.g., steps described herein with reference to the flow charts). In other embodiments, sending device 102 may be configured to perform steps described herein without the need for code. That is, for example, PC 402 may consist merely of one or more ASICs. Hence, the features of the embodiments described herein may be implemented in hardware and/or software.

### Conclusion

Because the sending device has access to the both the true depth (measured depth data) and the estimated depth (the depth data produced by the estimator), the sending device can determine whether or not there is an advantage to sending the measured depth data to a receiving device having a depth estimator with the capability to produce the estimated depth. For example, if the estimated depth is close to the depth measured by the LiDAR, then there is little to gained by providing the measured depth data to the receiving device and only the image data is transmitted, thereby saving network bandwidth as well as battery power.

While various embodiments are described herein, it should be understood that they have been presented by way of example only, and not limitation. Thus, the breadth and scope of this disclosure should not be limited by any of the above-described exemplary embodiments. Moreover, any combination of the above-described elements in all possible variations thereof is encompassed by the disclosure unless otherwise indicated herein or otherwise clearly contradicted by context.

As used herein transmitting data “to” or “toward” an intended recipient encompasses transmitting the data directly to the intended recipient or transmitting the data indirectly to the intended recipient (i.e., one or more other nodes are used to relay the message from the source node to the intended recipient). Likewise, as used herein receiving data “from” a sender encompasses receiving the data directly from the sender or indirectly from the sender (i.e., one or more nodes are used to relay the data from the sender to the receiving node). Further, as used herein “a” means “at least one” or “one or more.”

Additionally, while the processes described above and illustrated in the drawings are shown as a sequence of steps, this was done solely for the sake of illustration. Accordingly, it is contemplated that some steps may be added, some steps may be omitted, the order of the steps may be re-arranged, and some steps may be performed in parallel.

### REFERENCES

[1] Bross, B., et. al., “Overview of the Versatile Video Coding (VVC) Standard and its Applications,” in IEEE Transactions on Circuits and Systems for Video Technology, vol. 31, no. 10, pp. 3736-3764, October 2021, doi: 10.1109/TCSVT.2021.3101953.
[2] Wofk, D., et. al., “FastDepth: Fast Monocular Depth Estimation on Embedded Systems,” 2019 International Conference on Robotics and Automation (ICRA), 2019, pp. 6101-6108, doi: 10.1109/ICRA.2019.8794182.
[3] W3C, “Portable Network Graphics (PNG) Specification (Second Edition),” available at www(dot)w3(dot)org/TR/2003/REC-PNG-20031110.

1. A sending device, comprising:
an image sensor;
a depth sensor;
processing circuitry; and
memory storing instructions executable by the processing circuitry for configuring the sending device to:
obtain a measured depth map associated with at least a first image;
obtain an estimated depth map associated with at least the first image;
obtain a similarity measure indicating a similarity between the measured depth map and the estimated depth map;
determine, based at least in part on the similarity measure, whether a criteria is met, wherein determining whether the criteria is met comprises determining whether the similarity measure satisfies a condition; and
refrain from providing the measured depth map to a receiving device as a result of determining that the criteria is met.

2. The sending device of claim 1, wherein
the sending device is further configured to provide the measured depth map to the receiving device as a result of determining that the criteria is not met, and
the criteria is not met when the similarity measure does not satisfy the condition.

3. The sending device of claim 1, wherein
the similarity measure is an error value, and
the sending device determines that the error value satisfies the condition if the error value is less than a threshold, T.

4. The sending device of claim 3, wherein the error value is equal to:
∥Dm−D*∥ₚ, where p≥1, Dm is the measured depth map, and D* is the estimated depth map.

5. The sending device of claim 3, wherein the sending device determines that the criteria is met as a result of determining that the error value is less than T.

6. The sending device of claim 3, wherein the sending device determines that the criteria is met as a result of determining that: i) the error value is less than T and ii) bandwidth available to provide the measured depth map to the receiving device is less than a B, where B is a bandwidth threshold.

7. The sending device of claim 1, wherein the sending device is configured to obtain the estimated depth map by performing a process that includes:
inputting image data into a neural network; and
obtaining the estimated depth map from the neural network.

8. The sending device of claim 7, wherein
the sending device is further configured to: i) encode raw image data for the first image to produce encoded image data for the first image; and ii) decode the encoded image data to produce decoded image data for the first image, and
the image data input into the neural network comprises the decoded image data.

9. The sending device of claim 7, wherein
the image data input into the neural network comprises raw image data for the first image.

10. The sending device of claim 7, further comprising:
an image encoder for encoding raw image data for the first image to produce encoded image data for the first image;
an image decoder for decoding the encoded image data to produce decoded image data for the first image, wherein
the image data input into the neural network comprises the decoded image data if a bitrate, bn, is less than a threshold, otherwise the image data input into the neural network comprises the raw image data.

11. A method, comprising:
obtaining a measured depth map associated with at least a first image;
obtaining an estimated depth map associated with at least the first image;
obtaining a similarity measure indicating a similarity between the measured depth map and the estimated depth map;
determining, based at least in part on the similarity measure, that a criteria is met, wherein determining that the criteria is met comprises determining whether the similarity measure satisfies a condition; and
refraining from providing the measured depth map to a receiving device as a result of determining that the criteria is met.

12. The method of claim 11, wherein
the method is performed by a sending device, and
the sending device is configured to provide the measured depth map to the receiving device as a result of determining that the criteria is not met.

13. The method of claim 11, wherein
the similarity measure is an error value, and
the error value satisfies the condition if the error value is less than a threshold.

14. The method of claim 13, wherein the error value is equal to:
∥Dm−D*∥ₚ, where p≥1, Dm is the measured depth map, and D* is the estimated depth map.

15. The method of claim 13, wherein the criteria is met if the error value is less than the threshold.

16. The method of claim 13, wherein the criteria is met if: i) the error value is less than the threshold and ii) bandwidth available to provide the measured depth map to the receiving device is less than a B, where B is a bandwidth threshold.

17. The method of claim 11, wherein obtaining the estimated depth map comprises:
inputting image data into a neural network; and
obtaining the estimated depth map from the neural network.

18. The method of claim 17, further comprising:
encoding raw image data for the first image to produce encoded image data for the first image; and
decoding the encoded image data to produce decoded image data for the first image, wherein
the image data input into the neural network comprises the decoded image data.

19. (canceled)

20. The method of claim 17, further comprising:
encoding raw image data for the first image to produce encoded image data for the first image; and
decoding the encoded image data to produce decoded image data for the first image, wherein
the image data input into the neural network comprises the decoded image data if a bitrate, bn, is less than a threshold, otherwise the image data input into the neural network comprises the raw image data.

21. A non-transitory computer readable storage medium storing a computer program comprising instructions which when executed by processing circuitry of a sending device causes the sending device to perform the method of claim 11.

22. (canceled)
